(19) United States
(12) Patent Application Publication
(10) Pub. No.: US 2011/0006200 A1
(43) Pub. Date: Jan. 13, 2011

(54) Methods And Apparatus For Mass Spectrometry With High Sample Utilization

(75) Inventor: Alexander Loboda, Thornhill (CA)

Correspondence Address: RAUSCHENBACH PATENT LAW GROUP, LLP, P.O. BOX 387, BEDFORD, MA, 01730, US

(73) Assignee: DH TECHNOLOGIES DEVELOPMENT PTE. LTD., UOB Plaza (SG)

(21) Appl. No.: 12/829,244

(22) Filed: Jul. 1, 2010

Related U.S. Application Data
(60) Provisional application No. 61/223,542, filed on Jul. 7, 2009.

(51) Int. Cl. H01J 49/42; H01J 49/26; H01J 49/02

(52) U.S. Cl. 250/283; 250/281

(57) ABSTRACT

A method of measuring a mass spectrum with high sample utilization includes mass filtering a first group of precursor ions from a mass spectrum that has a first predetermined range of mass-to-charge ratios. At least one type of precursor ion in the first group of precursor ions is then selectively fragmented. A first fragment mass spectrum of the fragmented precursor ions in the first group of precursor ions is measured while maintaining other precursor ions in the first predetermined range of mass-to-charge ratios. A second group of precursor ions having a second predetermined range of mass-to-charge ratios is mass filtered from the mass spectrum. At least one type of precursor ion is selectively fragmented in the second group of precursor ions. A second fragment mass spectrum of the fragmented precursor ions in the second group of precursor ions is then measured.

### RELATED APPLICATION SECTION

This application claims priority to U.S. Provisional Patent Application Ser. No. 61/223,542, filed Jul. 7, 2009, entitled “Methods and Apparatus for Mass Spectrometry with High Sample Utilization,” the entire application of which is incorporated herein by reference.

The section headings used herein are for organizational purposes only and should not to be construed as limiting the subject matter described in the present application in any way.

### INTRODUCTION

Tandem mass spectrometers, which are sometimes referred to as MSn instruments, are mass spectrometers that are capable of performing multiple mass analysis steps. A mass spectrometer that is capable of performing two mass analysis steps is referred to as a MS-MS mass spectrometer and a tandem mass spectrometer capable of performing n mass analysis steps is referred to as an MSn mass spectrometer. Tandem mass spectrometers can be characterized as being either tandem-in-space or tandem-in-time. Tandem-in-space mass spectrometers have physically separated mass analyzers. Tandem-in-time mass spectrometers use the same mass analyzer(s) over and over again to perform sequentially all steps of selection and readout. A wide variety of tandem mass spectrometers with various types of mass analyzer sections are known in the art. The mass analyzer sections in the tandem mass spectrometers can be the same or can be different types of mass analyzers. For example, there are tandem mass spectrometers with quadrupole-quadrupole, magnetic sector-quadrupole, quadrupole-linear-ion-trap, and quadrupole-time-of-flight mass analyzers.

Tandem mass spectrometers provide information on the structure and sequence of ions under investigation (typically originating from biological materials) and allow unknown species in samples to be accurately identified. Tandem mass spectrometers are also used to quantify the amount of a known substance in a sample that contains many other components that can overlap with the substance of interest. Tandem mass spectrometers perform mass spectrometry measurements that contain multiple steps of ion interrogation, which are usually separated by some form of molecule fragmentation or chemical reaction. The multi-step mass spectrometry measurements enable researchers to perform a wide variety of structural and sequencing studies of molecules.

### BRIEF DESCRIPTION OF THE DRAWINGS

The present teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the applicant's teachings in any way.

FIG. 1 illustrates a functional block diagram of an MSn mass spectrometer including an ion trap that can be used to perform methods of measuring a mass spectrum with high sample utilization according to the present teaching.

FIG. 2 illustrates another functional block diagram of an MSn mass spectrometer including a mass filter and an ion trap that can be used to perform methods of measuring a mass spectrum with high sample utilization according to the present teaching.

FIG. 3 illustrates another functional block diagram of an MSn mass spectrometer including a mass filter, a fragmentation means, and an ion trap that can be used to perform methods of measuring a mass spectrum with high sample utilization according to the present teaching.

FIG. 4 illustrates another functional block diagram of an MSn mass spectrometer including a FT-ICR mass spectrometer that can be used to perform methods of measuring a mass spectrum with high sample utilization according to the present teaching.

FIG. 5 illustrates a block diagram of a mass spectrometer with high sample utilization according to the present teaching that includes an analysis section with a collision cell and an ion trap.

FIG. 6 illustrates exemplary mass spectra for a method of measuring a mass spectrum with high sample utilization according to the present invention that includes performing one or more sequences of mass filtering precursor ions, selectively fragmenting the precursor ion, and measuring the fragment mass spectrum.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

Tandem mass spectrometer experiments performed in modern instruments use ions inefficiently when interrogating multiple components. In a typical MS-MS instrument, the first step involves filtering a single component of interest while rejecting all other components. Consequently, the rejected components are not available for further analysis and thus the measurement efficiency is reduced.

The present teaching relates to methods and apparatus for mass spectrometry with high sample utilization. One aspect of the present teaching is using methods and apparatus that trap a set of precursor ions in a suitable ion trap and then manipulate this set of precursor ions in such a way as to get fragment ion spectra without discarding useful ions. Numerous types of mass spectrometers can be used to implement the present teachings. Tandem-in-time mass spectrometers, such as RF-ion trap (linear and 3-D), ion cyclotron resonance (which is also known as Penning trap and Fourier Transform Mass Spectrometer-FTMS), and hybrid mass spectrometers, such as quadrupole-linear-ion trap or quadrupole-FTMS can be used to implement the present teachings. Also, some tandem-in-space mass spectrometers can be used to implement the present teachings.

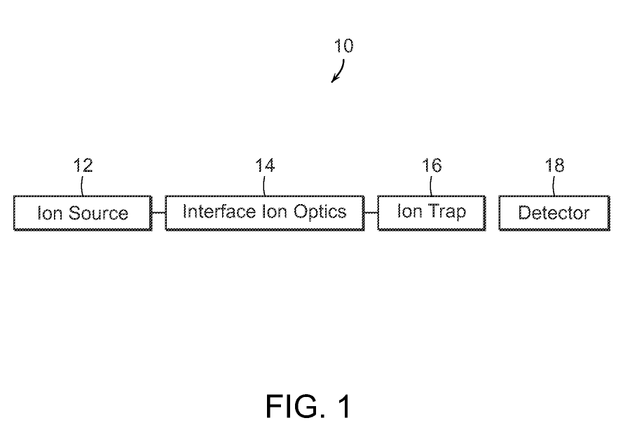

FIG. 1 illustrates a functional block diagram of an MSn mass spectrometer 10 including an ion trap that can be used to perform methods of measuring a mass spectrum with high sample utilization according to the present teaching. The MSn mass spectrometer 10 is a tandem-in-time mass spectrometer. The mass spectrometer 10 includes an ion source 12 that generates a plurality of precursor ions for analysis. Numerous types of ion sources, such as electrospray and laser desorption ion sources can be used. In one embodiment, the ion source is a MALDI ion source.

Interface ion optics 14 is used to focus the precursor ions into the analysis section that includes an ion trap 16. The interface ion optics 14 can include various components, such as an orifice plate that controls the number of ions entering the ion trap 16. A skimmer plate can be positioned adjacent to the orifice plate to form an intermediate pressure chamber. The skimmer plate is typically designed so that ions pass through the skimmer plate and into the ion trap 16. An ion guide can be used to collect and focus the precursor ions passing through the skimmer plate and to direct the ions to the ion trap 16 of the mass spectrometer 10. A curtain chamber can be provided that is designed to contain a curtain gas which reduces the flow of unwanted neutrals into the ion trap 16.

In various embodiments, the ion trap 16 can be a quadrupole ion trap (linear or three-dimensional) with selective collision induced dissociation fragmentation and resonance excitation filtering (SWIFT or FNF), a linear ion trap with mass selective ejection, or a Penning ion trap with selective collision induced dissociation fragmentation and resonance excitation filtering (CID or SORI CID). The ion trap 16 in the MSn mass spectrometer 10 is used to perform various functions. The ion trap 16 first traps and cools ions passing through the ion optics 14. The ion trap 16 can also be used to isolate certain precursor ions of interest. These isolated precursor ions of interest can then be fragmented using collisional induced dissociation, photofragmentation, or other means. Photofragmentation can be used to fragment all or certain types of precursor ions. The ion trap 16 then extracts the fragment ions so that the fragmentation spectrum can be read or detected by an ion detector 18, while leaving at least some other precursor ions remaining in the ion trap 16 for further analysis.

These ion trap functions can be repeated to isolate a second group of precursor ions of interest. The second group of precursor ions of interest are then fragmented using collisional induced dissociation, photofragmentation, or other means. The ion trap 16 then extracts the second fragmentation spectrum so that it can be detected by detector 18, while leaving at least some other precursor ions remaining in the ion trap 16 for further analysis. This method can be repeated until any number or all precursor ions are fragmented and extracted.

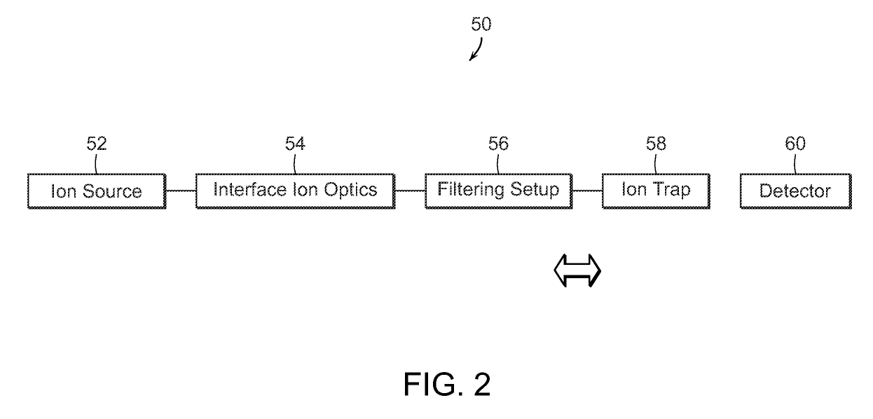

FIG. 2 illustrates a functional block diagram of an MSn mass spectrometer 50 including a mass filter and an ion trap that can be used to perform methods of measuring a mass spectrum with high sample utilization according to the present teaching. FIG. 2 is a mixed tandem-in-space and tandem-in-time mass spectrometer. The first filtering setup is physically separated from the second mass spectrometer (ion trap). The mass spectrometer 50 includes an ion source 52 that generates a plurality of precursor ions for analysis as described in connection with FIG. 1. Also, the mass spectrometer 50 includes interface ion optics 54, such as the interface ion optics 14 described in connection with FIG. 1, that are used to focus the precursor ions into an analysis section that includes a mass filter 56 and an ion trap 58.

The mass filter 56 is used to isolate precursor ions of interest for analysis. One skilled in the art will appreciate that one or more of numerous types of mass filters can be used in the mass filter 56. For example, the mass filter 56 can include a quadrupole mass filter that is designed to transmit only precursor ions of interest to the ion trap 58. The mass filter 56 can be used to substantially reduce the space charge in the ion trap 58 by eliminating all precursor ions that are not within the mass range of interest.

An ion trap 58 is positioned after the mass filter 56. The ion trap 58 traps and cools the fragmented precursor ions of interest. One skilled in the art will appreciate that any number of ion traps can be used. Also, one skilled in the art will appreciate that numerous types of ion traps can be used. The ion trap 58 can be any type of ion trap that is suitable for performing mass selective fragmentation, clearing ion population in certain mass-to-charge ratio regions of mass spectra, and reading the mass spectrum of fragment ions as described in connection with the mass spectrometer 10 of FIG. 1.

As described in connection with FIG. 1, the ion trap 58 in the MSn mass spectrometer 50 is used to perform various functions. The ion trap 58 first traps and cools ions passing through the ion optics 54. The ion trap 58 can also be used to isolate certain precursor ions of interest. Some or all of these isolated precursor ions of interest can then be fragmented using collisional induced dissociation, photofragmentation, or other means. The ion trap 58 then extracts the fragment ions so that the fragmentation spectrum can be read or detected by an ion detector 60, while leaving at least some other precursor ions remaining in the ion trap 58 for further analysis. In addition, the ion trap can transfer precursor ions back to the mass filter 56 for further processing or can transfer precursor ions back to the mass filter 56 in order to prevent these precursor ions from being fragmented in the ion trap.

These ion trap functions can be repeated to isolate a second group of precursor ions of interest. The second group of precursor ions of interest are then fragmented using collisional induced dissociation, photofragmentation, or other means. The ion trap 58 then extracts the second fragmentation spectrum so that it can be detected by the ion detector 60, while leaving at least some other precursor ions remaining in the ion trap 58 for further analysis. The ion trap can also transfer precursor ions back to the mass filter 56. This method can be repeated until any number or all precursor ions are fragmented and extracted.

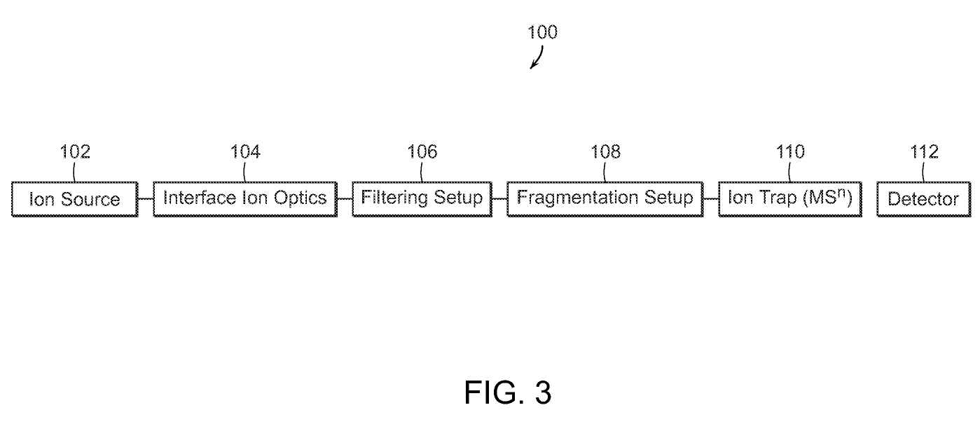

FIG. 3 illustrates another functional block diagram of an MSn mass spectrometer 100 including a mass filter, a fragmentation means, and an ion trap that can be used to perform methods of measuring a mass spectrum with high sample utilization according to the present teaching. The MSn mass spectrometer 100 shown in FIG. 3 is a mixed tandem-in-space and tandem-in-time mass spectrometer. The mass spectrometer 100 includes an ion source 102 that generates a plurality of precursor ions for analysis as described in connection with FIG. 1. Also, the mass spectrometer 100 includes interface ion optics 104, such as the ion optics 14 described in connection with FIG. 1, that are used to focus the precursor ions into the analysis section that includes a mass filter 106, a fragmentation means 108, and an ion trap 110.

A mass filter 106 is used to isolate precursor ions of interest for analysis. One skilled in the art will appreciate that one or more of numerous types of mass filters can be used in the mass filter 106 as described in connection with FIG. 1. The mass filter 106 can be used to substantially reduce the space charge in the analysis section by eliminating all precursor ions that are not within the mass range of interest.

A fragmentation means 108, such as a collision cell, is positioned after the mass filter 106 to fragment the precursor ions. The fragmentation means 108 can selectively or non-selectively fragment the filtered precursor ions. One skilled in the art will appreciate that there are numerous other types of fragmentation means, such as CAD (also known as CID), selective and non-selective photofragmentation, ECD, ETD, and metastable atom bombardment fragmentation.

One aspect of the present teaching is that the fragmentation caused by the fragmentation means 108 can be mass selective. For example, mass selective Collision-Activated Dissociation (CAD) can be used with resonance excitation of the precursor ion of interest. In addition, mass selective tools known in the art can be used to move at least a portion of the trajectory of selected ions away from the rest of the components and then cause fragmentation by overlapping the fragmentation laser beam with the part of the trajectory that is unique to selected ions. Photofragmentation can also be mass selective. For example, the wavelength of light used for the photofragmentation can be varied to selectively excite one or certain types of precursor ions but not others.

One or more ion traps 110 are positioned after the fragmentation means 108. The ion traps 110 trap and cool the fragmented precursor ions of interest. One skilled in the art will appreciate that any number of ion traps can be used. Also, one skilled in the art will appreciate that numerous types of ion traps can be used. The ion traps 110 can be any type of ion trap that is suitable for performing mass selective fragmentation, clearing ion population in certain mass-to-charge ratio regions of mass spectra, and reading the mass spectrum of fragment ions as described in connection with FIG. 1. In addition, the ion traps 110 can transfer precursor ions back to the fragmentation means 108 and/or the mass filter 106 for further processing or can transfer precursor ions back to the fragmentation means 108 and/or the mass filter 106 to prevent these precursor ions from being fragmented in the ion traps 110.

In various modes of operation, the ion traps 110 are used to perform various functions that isolate and eject desired or undesired fragment ions from the ion traps 110. For example, the ion traps 110 can be used to eject ions that have mass-to-charge ratios which overlap with expected fragments of precursor ions under analysis or future precursor ions that will be subject to analysis. Ejecting these ions will remove interferences that may otherwise complicate fragment ion spectra.

Precursor ions can also be transferred out of the ion trap for further mass filtering and/or fragmentation. In one mode of operation, the ion trap 110 ejects a portion of the ions back to the fragmenting means 108 for additional fragmentation and/or back to the mass filter 106 for further mass filtering. After the ions are subject to further fragmentation and mass filtering, these ions are again transferred to the ion trap 110 for further analysis. This ability to transfer precursor ions out of ion trap 110 for additional fragmentation and/or mass filtering and then transfer the processed ions back to into the ion trap 110 for further analysis greatly increases the choice of fragmentation methods and the range of conditions in the fragmentation setup. Such a capability may be important for many applications, especially applications where one fragmentation method may not provide sufficient information.

Furthermore, mass filtering and/or fragmentation can physically occur in the ion trap 110 itself. For example, in some embodiments, unwanted ions are trapped and then extracted from the ion trap 110. In some embodiments of the mass spectrometer 100, at least some of the fragmentation occurs in the ion trap 110. In these embodiments, precursor ions with mass-to-charge ratios of interest are selectively fragmented for analysis.

The desired precursor ions and fragments thereof are then extracted so they can be readout or detected by an ion detector 112. For example, in linear ion traps, the desired precursor ions and fragments thereof can be readout by mass selective axial ejection or radial ejection. The ion detector 112 is positioned adjacent to the ion trap 110 to detect ions ejected from the ion trap 110. One skilled in the art will appreciate that numerous types of ion detection systems can be used. For example, Ion Cyclotron Resonance (ICR) mass analyzer spectra of fragment ions and precursor ions can be read out by typical ion charge pick-up detection system with Fourier Transform analysis.

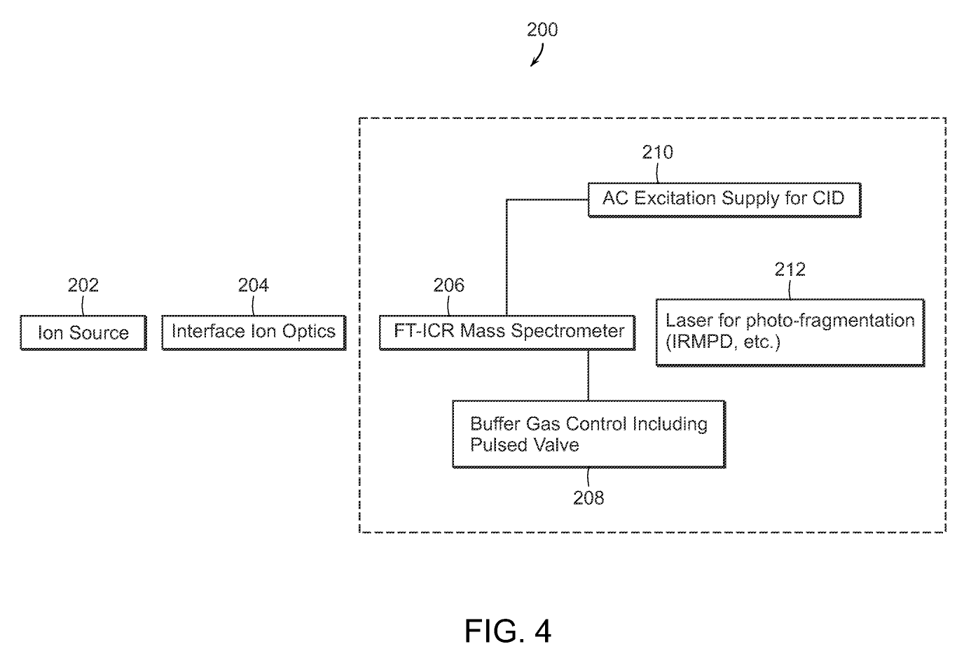

FIG. 4 illustrates another functional block diagram of an MSn mass spectrometer 200 including a Fourier transform ion cyclotron resonance (FT-ICR) mass spectrometer that can be used to perform methods of measuring a mass spectrum with high sample utilization according to the present teaching. The MSn mass spectrometer 200 is a more specific description of the MSn mass spectrometer 10 described in connection with FIG. 1 where the ion trap is a Penning ion trap.

The mass spectrometer 200 includes an ion source 202 that generates a plurality of precursor ions for analysis as described in connection with FIG. 1. Also, the mass spectrometer 200 includes interface ion optics 204, such as the ion optics 14 described in connection with FIG. 1, which are used to focus the precursor ions into the analysis section that includes a FT-ICR mass spectrometer 206.

Fourier transform ion cyclotron resonance mass spectrometry is a type of mass spectrometer that determines the mass-to-charge ratio (m/z) of ions based on the cyclotron frequency of the ions in a fixed magnetic field. Ions are trapped in a Penning trap where they are excited to a cyclotron radius by an oscillating electric field perpendicular to the magnetic field. The excitation causes the ions to propagate across a pair of plates. A current signal is detected on the pair of plates as a superposition of sine waves. A mass spectrum is obtained by performing a Fourier transform of the resulting superposition of sine waves to resolve the masses in frequency. All ions can be detected simultaneously over some given period of time.

The FT-ICR mass spectrometer 206 can also function as a collision cell for fragmenting precursor ions. A buffer or collision gas source 208 is coupled to the collision cell through control valves. An AC excitation power supply 210 for collision-induced dissociation (CID), which is sometimes referred to as collisionally activated dissociation (CAD), is coupled to the collision cell. The AC excitation power supply 210 generates an AC electric field that selectively accelerates precursor ions to a relatively high kinetic energy and then allows them to collide with neutral gas molecules comprising the collision gas (often helium, nitrogen or argon). During collisions, some of the kinetic energy is converted into internal energy of ions which results in bond breakage and the fragmentation of precursor ions into smaller pieces. These fragment ions are then analyzed in the FT-ICR mass spectrometer 206.

In some embodiments, a laser or a photo-fragmentation device 212 is coupled to the inside of the FT-ICR mass spectrometer 206 through a window. For example, a laser can be coupled to the FT-ICR mass spectrometer 206 to perform infrared multi-photon dissociation (IRMPD) to fragment precursor ions. Infrared multi-photon dissociation uses infrared radiation to cause the precursor ions to absorb multiple infrared photons, thereby exciting the precursor ions into more energetic vibrational states where bond(s) are eventually broken resulting in gas phase fragments of the precursor ions.

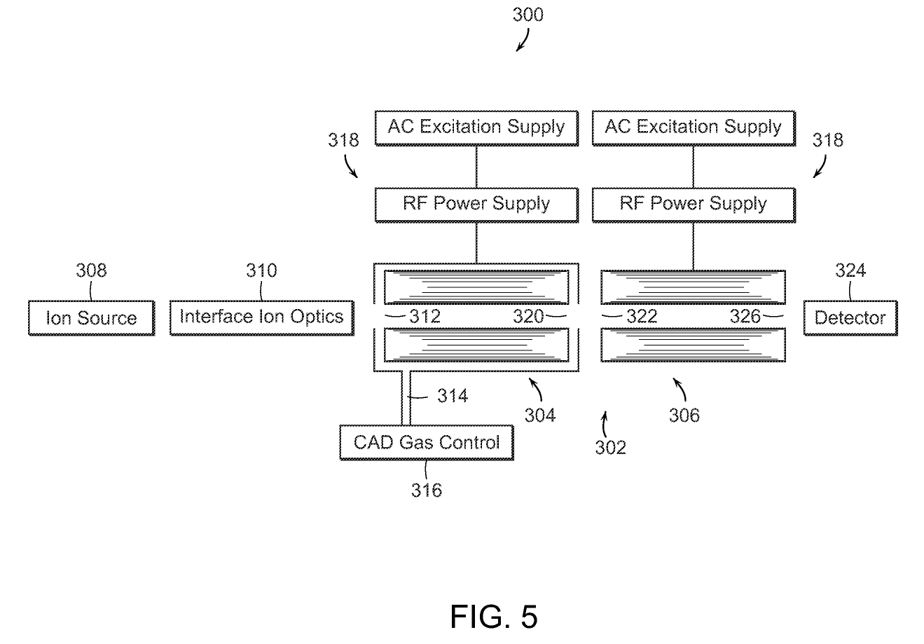

FIG. 5 illustrates a block diagram of a mass spectrometer 300 with high sample utilization according to the present teaching that includes an analysis section 302 with a collision cell 304 and an ion trap 306. The mass spectrometer 300 is primarily a tandem-in-time mass spectrometer because both mass analysis and filtering is performed with the ion trap 306. However, the fragmentation is performed tandem-in-space because selective fragmentation is performed in this embodiment with the collision cell 304

The mass spectrometer 300 includes an ion source 308 that generates a plurality of precursor ions for analysis as described in connection with the mass spectrometer of FIG. 1. In addition, the mass spectrometer 300 includes interface ion optics 310 that is used to focus the precursor ions into the analysis section 302 of the mass spectrometer 300.

The collision cell 304 shown in FIG. 5 is a gas-phase collision-activated dissociation (CAD) cell that performs selective fragmentation. The collision cell 304 includes an input 312 that receives the precursor ions from the interface ion optics 310. The collision cell 304 also includes a gas input 314 that is coupled to a CAD gas source controller 316 that controls the flow of CAD gas into the CAD collision cell 304. The collision cell 304 also includes power supplies 318 that provide energy for excitation of precursor ions of interest to facilitate energetic collisions between chosen precursor ions and CAD gas molecules. For example, the power supplies 318 can include an AC excitation power supply that generates AC voltages superimposed on top of the RF voltage generated by the RF power supply. The RF component of the power supplies 318 provides confinement of all ions along the axis while the AC component pumps up kinetic energy of precursor ions of interest, thereby inducing energetic collisions with the chosen precursor ions. The collision cell 304 also includes an output 320 for passing the precursor ions and fragments thereof.

The ion trap 306 includes an input 322 that is positioned to receive precursor ions and fragments thereof from the collision cell 304. Numerous ion traps, such as the ion traps described in connection with the ion trap 16 of FIG. 1 can be used. The ion trap 306 can perform various filtering and/or fragmentation functions. The ion trap 306 can filter unwanted ions by ejecting them from the ion trap 306 before extracting the precursor ions and fragments thereof that are subject to the desired measurement. The ion trap 306 can also isolate and transport precursor ions and fragments thereof back to the CAD collision cell 304 for further fragmentation. These fragmented ions are then transported back to the ion trap 306 for isolation, filtering, and eventually for extracting the precursor ions and fragments thereof so they can be detected.

Pressure of the buffer gas in the ion trap 306 can be adjusted to the desired level using buffer gas control apparatus. In some modes of operation, it is advantageous to set the pressure of the buffer gas relatively high (for example, in the range of 0.1-100 mTorr) to accelerate the trapping. In other modes of operation, it is advantageous to reduce the pressure during the readout portion of the analysis in order to improve the resolution and/or efficiency of the readout scan.

One skilled in the art will appreciate that any number of ion traps can be used. Multiple ion traps can be used to isolate certain precursor ions and/or fragments thereof for further processing or can be used to prevent these ions and fragments thereof from being fragmented. Multiple ion traps can also be used to move ions back-and-forth between ion traps in a closed process loop.

An ion detector 324 is positioned adjacent to the output 326 of the ion trap 306 to detect ions ejected from the ion trap 306. The ion detector 324 is synchronized to the operation of the ion trap 306. The ion trap 306 extracts or reads out the desired precursor ions and fragments thereof and these ions and fragments thereof are detected by the ion detector 324. For example, in linear ion traps, the desired precursor ions and fragments thereof can be readout by mass selective axial ejection or by radial ejection.

One skilled in the art will appreciate that numerous other MSn mass spectrometers and variations thereof can be used to practice the methods of measuring a mass spectrum with high sample utilization according to the present teaching. For example, one skilled in the art will appreciate that the mass spectrometer 300 can have any number of MSn processing sequences. When multiple MSn sequences are employed, the fragment ions from the previous fragmentation cycle are used as the precursor ions in the following MSn sequence.

Methods of measuring a mass spectrum with high sample utilization according to the present teaching include trapping precursor ions with different mass-to-charge ratios. Precursor ions with mass-to-charge ratios corresponding to mass-to-charge ratios of precursor ion fragments are removed while retaining other precursor ions for analysis. A first set of precursor ions is then selectively fragmented. The spectrum of fragmented ions is then detected. This method can be repeated for further sets of precursor ions.

More specifically, a method of measuring a mass spectrum with high sample utilization according to the present teaching includes generating precursor ions for analysis. In some methods according to the present teaching, the precursor ions include mostly singly charged ions. Also, in some methods according to the present teaching, the first group of precursor ions is generated with a MALDI ion source. MALDI generates ions on demand. In these methods, the MALDI ion source parameters, such as laser fluence and number of laser pulses per ion trap cycle can be adjusted to control the space charge in the ion trap. MALDI generates predominantly singly charge ions. Therefore, fragments of these ions tend to have mass-to-charge ratios below the mass-to-charge ratio of the precursor ions, which makes it easier to clear out a particular mass-to-charge ratio range from the ion trap so that the desired ion fragments can be accurately detected.

A first group of precursor ions with a first predetermined range of mass-to-charge ratios is filtered from a mass spectrum. The mass filtering of the first group of precursor ions includes removing ions having mass-to-charge ratios in a range corresponding to a range of mass-to-charge ratios of fragmented precursor ions in the first group of precursor ions. One skilled in the art will appreciate that the first group of ions can be mass filtered in numerous ways. For example, the first group of ions can be mass filtered by trapping ions in a quadrupole or a linear ion trap, and/or can be mass filtered by performing resonance excitation.

At least one type of precursor ion in the first group of precursor ions is then selectively fragmented. One skilled in the art will appreciate that there are numerous methods of selectively fragmenting precursor ions in the first group of precursor ions. For example, the methods of selectively fragmenting the precursor ions include physically separating a portion of the at least one type of precursor ion and then fragmenting the physically separated portion. Selective fragmentation of the precursor ions can also be accomplished by performing resonance excitation of the precursor ions, performing mass selective collision induced dissociation fragmentation, and by performing photofragmentation with particular wavelengths. A first fragment mass spectrum of the fragmented precursor ions in the first group of precursor ions is measured while maintaining other precursor ions in the first predetermined range of mass-to-charge ratios for further analysis. The first mass spectrum measurement can be a destructive or a non-destructive measurement.

A second group of precursor ions having a second predetermined range of mass-to-charge ratios is then mass filtered. One skilled in the art will also appreciate that the second group of ions can be mass filtered in numerous ways. For example, the second group of ions can be mass filtered by trapping ions in a quadrupole or a linear ion trap, or can be mass filtered by performing resonance excitation.

At least one type of precursor ion in the second group of precursor ions is then selectively fragmented. One skilled in the art will also appreciate that there are numerous methods of selectively fragmenting the precursor ions in the second group. For example, the methods of selectively fragmenting the precursor ions include physically separating a portion of the at least one type of precursor ion and then fragmenting the physically separated portion. Selective fragmentation of the precursor ions can also be accomplished by performing resonance excitation of the precursor ions, performing mass selective collision induced dissociation fragmentation, and by performing photofragmentation. The resulting second fragment mass spectrum of the fragmented precursor ions in the second group of precursor ions is then measured. The mass spectrum measurement can be a destructive or a non-destructive measurement.

In one method of the present teaching, the mass filtering the first group of precursor ions, the selectively fragmenting the precursor ion in the first group of precursor ions, and the measuring the first fragment mass spectrum are performed in a first ion trap while the mass filtering the second group of precursor ions, the selectively fragmenting the precursor ion in the second group of precursor ions, and the measuring the second fragment mass spectrum are performed in a second ion trap, which is physically separate from the first ion trap.

This method of measuring a mass spectrum with high sample utilization according to the present teaching can be continued by mass filtering one or more additional groups of precursor ions, selectively fragmenting the precursor ion in these additional groups of precursor ions, and then measuring the resulting fragment mass spectrums. For example, this method of measuring a mass spectrum with high sample utilization can include mass filtering a third group of precursor ions from the mass spectrum having a third predetermined range of mass-to-charge ratios, selectively fragmenting precursor ions in the third group of precursor ions; and measuring a third fragment mass spectrum of the fragmented precursor ions. Thus, methods of the present teaching can be used to generate mass spectra with any level of mass filtering and with high sample utilization by repeating the steps of mass filtering, selective fragmentation, and measuring the resulting fragment mass spectrums.

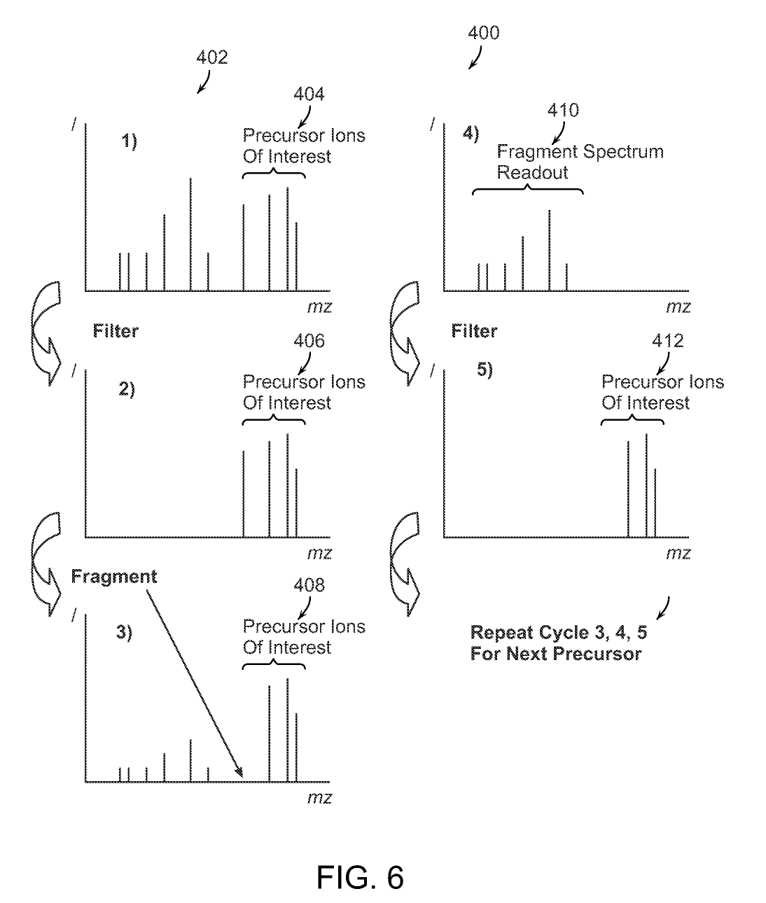

FIG. 6 illustrates exemplary mass spectra 400 for a method of measuring a mass spectrum with high sample utilization according to the present invention that includes performing one or more sequences of mass filtering precursor ions, selectively fragmenting the precursor ion, and measuring the fragment mass spectrum. The first mass spectrum 402 illustrates a mass spectrum of the population of precursor ions which have been generated for analysis. For example, the precursor ions can be generated by MALDI so that they include mostly singly charged ions. The first mass spectrum 402 represents the ion population in the ion trap and identifies a mass-to-charge ratio range 404 of precursor ions of interest. A second mass spectrum 406 illustrates a mass spectrum of a filtered population of ions that shows only the precursor ions of interest remaining in the ion trap after filtering.

A third mass spectrum 408 illustrates the mass spectrum of the filtered population of ions shown in the second mass spectrum 406 after a precursor ion with the lowest mass-to-charge ratio has been fragmented. In particular, the third mass spectrum 408 shows that the precursor ion of interest with the lowest mass-to-charge ratio has been fragmented. In addition, the third mass spectrum 408 shows the corresponding fragmented spectrum for the precursor ion of interest with the lowest mass-to-charge ratio. The fourth mass spectrum 410 shows only the fragment spectrum for the precursor ion of interest with the lowest mass-to-charge ratio. This mass spectrum 410 can be recorded using destructive or non-destructive detection. The fifth mass spectrum 412 shows only the remaining unfragemented precursor ions of interest. The fifth mass spectrum 412 is similar to the second mass spectrum 406, but the precursor ion of interest with the lowest mass-to-charge ratio has been processed and, therefore, is not present. In some modes of operation, additional precursor ions of interest are fragmented and the third mass spectrum 408, fourth mass spectrum 410, and fifth mass spectrum 412 are repeated for the additional fragmented precursor ions.

Another method of measuring fragment mass spectra with high sample utilization includes trapping a group of precursor ions having a predetermined range of mass-to-charge ratios. One skilled in the art will appreciate that numerous types of ion trapping can be used. For example, the ion trapping can be performed in a linear RF ion trap employing buffer gas to slow down injected ions. The ion population can be preselected using resonance excitation filtering. The remaining precursor ions can be fragmented in sequence via selective collision induced dissociation.

The precursor ions with mass-to-charge ratios corresponding to mass-to-charge ratios of future fragments of the precursor ions of interest are mass filtered. This mass filtering reduces the probability of detecting erroneous fragment ion signals caused by the presence of precursor ions at the same mass-to-charge ratio as the fragment ions.

At least one type of precursor ion in the group of precursor ions is then selectively fragmented. One skilled in the art will appreciate that there are numerous methods of selectively fragmenting the precursor ions. For example, some methods of selectively fragmenting the precursor ions include physically separating a portion of the precursor ions and then fragmenting the physically separated portion. Selective fragmentation of the precursor ions can also be accomplished by performing resonance excitation of the precursor ions, performing mass selective collision induced dissociation fragmentation, and by performing photofragmentation.

A mass spectrum of the fragmented precursor ions in the group of precursor ions is measured. The mass spectrum measurements can be performed destructively or non-destructively. The steps of trapping precursor ions, mass filtering precursor ions, selectively fragmenting at least one type of precursor ion, and measuring the mass spectrum for a different group of precursor ions are then repeated until a desired mass spectrum is measured at a desired mass resolution. In some embodiments, all the steps of trapping precursor ions, mass filtering precursor ions, selectively fragmenting, and measuring the mass spectrum are preformed in one ion trap. In other embodiments, the steps of trapping precursor ions, mass filtering precursor ions, selectively fragmenting, and measuring the mass spectrum are preformed in multiple ion traps.

Researchers are typically working with samples that contain complex mixtures and, therefore, they are interested in obtaining information about more than one precursor ion fragment. In addition, researchers often have limited sample quantities for various reasons. These steps of trapping precursor ions, mass filtering precursor ions, selectively fragmenting, and measuring the mass spectrum while maintain other precursor ions for further analysis greatly increase the sample utilization. Using the methods and apparatus of the present teaching will result in more information being extracted from a limited amount of sample material. The increase in sample utilization is proportional to the number of precursor ions fragmented. Even when the sample under investigation contains only one component, there are measurements where first generation fragments (also called MS-MS or MS2 fragments) do not carry sufficient information. Therefore researchers resort to MSn measurements which require further fragmentation of fragment ions. MSn spectra for the component of interest can be obtained with substantially higher efficiency using the approach of the present invention.

### EQUIVALENTS

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art, which may be made therein without departing from the spirit and scope of the teaching.

What is claimed is:

1. A method of measuring a mass spectrum with high sample utilization, the method comprising:
a. mass filtering a first group of precursor ions from a mass spectrum, the first group of precursor ions having a first predetermined range of mass-to-charge ratios;
b. selectively fragmenting at least one type of precursor ion in the first group of precursor ions;
c. measuring a first fragment mass spectrum of fragmented precursor ions in the first group of precursor ions while maintaining other precursor ions in the first predetermined range of mass-to-charge ratios;
d. mass filtering a second group of precursor ions from the mass spectrum, the second group of precursor ions having a second predetermined range of mass-to-charge ratios;
e. selectively fragmenting at least one type of precursor ion in the second group of precursor ions; and
f. measuring a second fragment mass spectrum of the fragmented precursor ions in the second group of precursor ions.

2. The method of claim 1 wherein at least one of the mass filtering of the first and the second group of precursor ions comprises trapping ions in a quadrupole ion trap.

3. The method of claim 1 wherein the at least one of the mass filtering of the first and the second group of precursor ions comprises trapping ions in a linear ion trap.

4. The method of claim 1 wherein at least one of the mass filtering of the first and the second group of precursor ions comprises trapping ions in a Penning ion trap.

5. The method of claim 1 wherein at least one of the mass filtering of the first and the second group of precursor ions comprises performing resonance excitation.

6. The method of claim 1 wherein the mass filtering of the first group of precursor ions comprises removing ions having mass-to-charge ratios in a range corresponding to a range of mass-to-charge ratios of fragmented precursor ions in the first group of precursor ions.

7. The method of claim 1 wherein the selectively fragmenting the at least one type of precursor ion in the first and the second groups of precursor ions comprises performing resonance excitation of the precursor ions.

8. The method of claim 1 wherein the selectively fragmenting the at least one type of precursor ion in the first and the second group of precursor ions comprises performing mass selective collision induced dissociation fragmentation.

9. The method of claim 1 wherein the selectively fragmenting at least one type of precursor ion in the first and the second group of precursor ions comprises performing photofragmentation.

10. The method of claim 1 wherein the selectively fragmenting at least one type of precursor ion in the first and the second group of precursor ions comprises physically separating a portion of the at least one type of precursor ion and then fragmenting the physically separated portion.

11. The method of claim 1 wherein the measuring at least one of the first fragment mass spectrum and the second fragment mass spectrum comprise a non-destructive measurement.

12. The method of claim 1 wherein the measuring at least one of the first fragment mass spectrum and the second fragment mass spectrum comprise a destructive measurement.

13. The method of claim 1 wherein at least one of the first and the second groups of precursor ions are substantially singly charged ions.

14. The method of claim 1 further comprising the steps of generating the first and second groups of precursor ions with a MALDI ion source.

15. The method of claim 14 further comprising adjusting at least one of a laser fluence and a number of laser pulses per ion trap cycle in the MALDI ion source to generate a desired first and second groups of precursor ions.

16. The method of claim 1 wherein the steps of mass filtering the first group of precursor ions, selectively fragmenting the at least one type of precursor ion in the first group of precursor ions, and measuring the first fragment mass spectrum of the fragmented precursor ions in the first group of precursor ions are performed in a first ion trap and the steps of mass filtering the second group of precursor ions, selectively fragmenting the at least one type of precursor ion in the second group of precursor ions, and measuring the second fragment mass spectrum of the fragmented precursor ions in the second group of precursor ions are performed in a second ion trap.

17. The method of claim 1 further comprising:
a. mass filtering a third group of precursor ions from the mass spectrum, the third group of precursor ions having a third predetermined range of mass-to-charge ratios;
b. selectively fragmenting at least one type of precursor ion in the third group of precursor ions; and
c. measuring a third fragment mass spectrum of the fragmented precursor ions in the third group of precursor ions.

18. A method of measuring a mass spectrum with high sample utilization, the method comprising:
a. trapping a group of precursor ions, the group of precursor ions having a predetermined range of mass-to-charge ratios;
b. mass filtering precursor ions having mass-to-charge ratios corresponding to mass-to-charge ratios of fragments of the precursor ions;
c. selectively fragmenting at least one type of precursor ion in the group of precursor ions;
d. measuring a mass spectrum of the fragmented precursor ions in the group of precursor ions; and
e. repeating the steps of trapping precursor ions, mass filtering precursor ions, selectively fragmenting at least one type of precursor ion, and measuring the mass spectrum for a different group of precursor ions until all desired mass spectra are measured.

19. The method of claim 18 wherein the steps of trapping the group of precursor ions, mass filtering the precursor ions, selectively fragmenting at least one type of precursor ion, and measuring the mass spectrum for a different group of precursor ions are performed in an ion trap.

20. The method of claim 19 wherein the ion trap comprises a quadrupole ion trap with selective collision induced dissociation fragmentation and resonance excitation filtering.

21. The method of claim 19 wherein the ion trap comprises a linear ion trap with mass selective ejection.

22. The method of claim 19 wherein the ion trap comprises a Penning ion trap with selective collision induced dissociation fragmentation and resonance excitation filtering.

23. The method of claim 19 wherein the selectively fragmenting the at least one type of precursor ion in the group of precursor ions comprises performing photofragmentation.

24. The method of claim 18 wherein the selectively fragmenting the at least one type of precursor ion in the group of precursor ions comprises performing mass selective collision induced dissociation fragmentation.

25. The method of claim 18 wherein the selectively fragmenting the at least one type of precursor ion in the group of precursor ions comprises performing resonance excitation of the precursor ions.

26. The method of claim 18 wherein the measuring the mass spectrum of the fragmented precursor ions in the group of precursor ions comprises non-destructively measuring the mass spectrum.

27. The method of claim 18 wherein the measuring the mass spectrum of the fragmented precursor ions in the group of precursor ions comprises destructively measuring the mass spectrum.

28. A mass spectrometer with high sample utilization, the mass spectrometer comprising:
a. means for trapping a group of precursor ions in a mass spectrum, the group of precursor ions having a predetermined range of mass-to-charge ratios;
b. means for filtering precursor ions having mass-to-charge ratios corresponding to mass-to-charge ratios of fragments of the precursor ions;
c. means for selectively fragmenting at least one type of precursor ion in the group of precursor ions; and
d. means for measuring a mass spectrum of the fragmented precursor ions in the group of precursor ions while maintaining other precursor ions in the predetermined range of mass-to-charge ratios.
